(19) United States
(12) Patent Application Publication
(10) Pub. No.: US 2010/0077958 A1
(43) Pub. Date: Apr. 1, 2010

(54) CLEANING APPARATUS

(76) Inventor: Michael Arthur Fitch, Willoughby (AU)

Correspondence Address: QUICKPATENTS, INC., 32861 CALLE PERFECTO, SUITE A, SAN JUAN CAPISTRANO, CA, 92675, US

(21) Appl. No.: 12/531,451

(22) PCT Filed: Mar. 4, 2008
(86) PCT No.: PCT/AU08/00293

§ 371 Date: Sep. 15, 2009

Related U.S. Application Data
(60) Provisional application No. 60/907,004, filed on Mar. 16, 2007.

(51) Int. Cl. B05C 11/00; B08B 13/00

(52) U.S. Cl. 118/203; 134/201; 15/256.51

(57) ABSTRACT

A cleaning apparatus suitable for cleaning a roll coating machine is described, the cleaning apparatus having one or more rolls and including: a cleaning means; and a support chassis for supporting the cleaning means adjacent the one or more rolls. A roll coating machine is also described, which includes a cleaning apparatus, comprising a cleaning means; and a support chassis for supporting the cleaning means adjacent the one or more rolls.

### CROSS-REFERENCE TO RELATED APPLICATIONS

This application claims the benefit of PCT Application PCT/AU2008/000293, filed on Mar. 4, 2008, and incorporated herein by reference.

### STATEMENT REGARDING FEDERALLY SPONSORED RESEARCH AND DEVELOPMENT

Not Applicable.

### FIELD OF THE INVENTION

This invention relates generally to a cleaning device suitable for cleaning roll coating machines of the type which apply a coating to strips and coils of steel and other material strips and coils, and to roll coating machines themselves having cleaning attachments. Generally speaking, roll coating machines include a pickup roll, a metering roll and an applicator roll.

### BACKGROUND TO THE INVENTION

It is difficult to properly and safely clean roll necks and shoulders of roll coating machines. This is complicated by the various shapes, angles, and radiuses of the roll necks and shoulders. Known methods involve a machine operator holding a solvent-impregnated rag against the roll necks and shoulder of counter-rotating rolls. As can be appreciated, this procedure is very dangerous and can result in serious injury and operator limb loss through contact with nip points. Furthermore, skin contact with cleaning solvents or breathing solvent vapours is undesirable, and wearing gloves merely serves to reduce accuracy and increase the likelihood of pinch injuries. Furthermore, roll necks and shoulders of roll coating machine quickly become coated with coating fluids, which must be effectively removed at the completion of each production run. The present invention seeks to ameliorate one or more of the above-mentioned disadvantages.

### SUMMARY OF THE INVENTION

According to one aspect of the present invention there is provided a cleaning apparatus suitable for cleaning a roll coating machine having at least one roll, each roll comprising at least one roll neck, at least one roll shoulder and one roll face, the cleaning apparatus adapted to be mounted to the roll coating machine and including: a cleaning means for cleaning the at least one roll neck and/or shoulder; and a support chassis for supporting the cleaning means adjacent the at least one roll.

Preferably, the cleaning means is adapted to clean the roll face.

The cleaning means may be in any suitable form, such as for example spray nozzles or heads, or blower nozzles or heads, or vacuum heads and the like, but in a preferred form the cleaning means is a contact means in the form of a wiper element. The wiper element may be in any suitable form such as for example a rubber or other type of resilient blade, or a sponge or scourer, but in preferred embodiments the wiper element is a cloth element, preferably a cloth strip.

Preferably the wiper element corresponds in profile with at least one angled surface of each roll neck, shoulder radiuses and at least one roll of the roll coating machine. In one preferred embodiment, at least one die or mandrel or similar device is provided so that when the wiper element extends between a first and second ends, a wiping surface of the is wiping element corresponds in shape to at least one surface of the at least one roll neck and shoulder of the roll coating machine roll.

Preferably the support chassis includes a mounting spine for mounting the at least one die or mandrel so that when they in an operating position abut each roll neck and, or shoulder or end surfaces, in a compliant manner. Preferably the mounting spine is an elongate shaft. Preferably the die or mandrel is adapted to pivot about the elongate shaft, about a longitudinal shaft axis to facilitate broader contact between the cloth strip and the at least one surface of the at least one roll of the roll coating machine.

Preferably the support chassis includes at least one guide means for guiding the cloth strip so as to improve locating the cloth strip relative to the surfaces of at least one roll and to facilitate relative movement between the cloth strip and the at least one roll of the roll coating machine for renewal of the cloth strip.

Preferably there is provided a transport means for transporting the cloth strip relative to the at least one roll of the roll coating machine. Preferably the transport means includes a delivery or uncoiling means to deliver or supply clean cloth strip from a supply coil to the at least one die or mandrel. Preferably the transport means further includes drawing means so as to draw clean cloth from the uncoiling means or supply coil. Also, the transport means may include a packing means to pack spent cloth strip which has cleaned the roll face, neck and/or end surfaces of the at least one roll of the roll coating machine. The packing means may include a coiling means for recoiling the spent strip onto a spent coil or a dumping means which includes a shear and dump box for transport of spent cloth strip, sheared into selected lengths, to a dump or recycling or cleaning facility.

Preferably the coiling means includes an indexing means so as to facilitate drawing the cloth strip from the supply coil, the indexing means being preferably in the form of a ratchet operated by a pneumatic cylinder.

Preferably the support chassis includes a solvent delivery means for delivering solvent to the cleaning cloth strip. In one form the solvent delivery means includes galleries associated with or disposed within the support spine and/or dies or mandrels, so as to impregnate the cleaning cloth strip at approximately the time of passing between the die and the roll or roll neck surface.

Preferably the guide means include folding or tucking means so that the cleaning cloth strip may form a convex shape so as to facilitate cleaning of roll end faces and the like. Generally the cleaning cloth forms a U-shape adjacent the coating machine rolls when in operation hi one form the guide means include guide blocks which comprise guide slots which are open at a base for receiving a side region of the cloth strip and are disposed generally perpendicular to a plane of an upstream cleaning cloth strip. Preferably an upstream guide block and a downstream guide block are provided for each die or mandrel so as to feed the cloth strip to and from the die or mandrel profile.

Preferably the guide blocks are pivotally mounted on the mounting spine so as to facilitate close correspondence of the contour of the cloth strip with the contour of the roll or roll end or roll neck surface.

It may be in some embodiments that the support chassis and cleaning element is the full width of a roll and neck of the at least one roll of the coating machine. Preferably, however, the support chassis and cleaning element is narrow compared to the width of the roll, and a traversing means is provided so as to traverse across the surface of the roll and neck at a selected speed. In one optional form the traversing means is mounted on the pickup roll support structure.

A linear actuator being hydraulic, pneumatic or electric, and which includes a linear track may be included with the traversing means, and the track may extend to one side of the coating machine so that the spine may adopt a parked position in which the cleaning track does not interfere with a coating operator's view of the coating operation. Furthermore, transducers such as position and pressure sensors may be provided with the traversing means so as to provide feedback to a logic controller which may control the traverse of the cleaning element. The traversing means may include a counterbalance assembly so as to maintain side-to-side accuracy of measurement of roll force between pickup rolls and applicator rolls when the coating machine is in coating operation.

According to another aspect of the present invention there is provided a reservoir which is suitable for use in coating a strip or coil with a roll coating machine, the reservoir including: a first chamber suitable for receiving fluid from coating machine rolls; and a second chamber disposed at the periphery of the first chamber for receiving coating overspray or coating droplets.

Preferably the first and second chambers include drainage means so as to drain fluid within the first and second chambers to respective first and second drains. Preferably the drainage means include tapered walls and tapered floors. In preferred embodiments the second chamber in cross-section is in the form of a V-shaped chamber.

In preferred embodiments the second chamber drains to a scrap drum. Preferably the first chamber may retain coating fluid so that a pick-up roll may be immersed in the fluid while coating a coil.

According to yet another aspect of the present invention there is provided a cleaning apparatus for cleaning a reservoir associated with a roll coating apparatus, the cleaning apparatus including: a cleaning means and a support chassis for supporting the cleaning means proximal the reservoir.

Preferably the cleaning means includes a spray system which includes spray nozzles and/or floodjet nozzles. In some embodiments it is contemplated that the support chassis extends the width of the reservoir, however, preferably there is provided a part-width support chassis, in one form, a spray bar which extends in one direction (length or width of the machine). In this preferred embodiment, a traversing means is provided so as to traverse the spray bar to cover the reservoir with cleaning fluid. Preferably the spray bar extends the length of a roll of the roll coating machine, and the traverse means extends perpendicular to the roll length. The traverse means may be a linear actuator actuated by hydraulic means, electrical means or pneumatic means.

According to a still further aspect of the present invention there is provided a roll coating machine for coating coil or strip, the roll coating machine including at least one roll, the roll coating machine including: a cleaning means for cleaning the at least one roll; and a support chassis for supporting the cleaning means adjacent the at least one roll.

Preferably the cleaning means is in the form of a contact cleaning means in the form of a wiper element. The wiper element may be in any suitable form such as for example a rubber or other type of resilient blade, or a sponge or scourer, but in preferred embodiments the wiper element is a cloth element, preferably a cloth strip.

Preferably the wiper element corresponds in profile with at least one surface of the at least one roll of the roll coating machine. In one preferred embodiment a die or a mandrel is provided so as to mould or contour the cloth strip to at least one surface of the at least one roll of the roll coating machine, including roll ends and roll necks for more effective cleaning.

Preferably the support chassis includes a mounting spine for mounting at least one die or mandrel so they abut the roll or roll neck or end surfaces. Preferably the mounting spine is an elongate shaft so that the die or mandrel may pivot about a longitudinal shaft axis to facilitate profile correspondence with the at least one surface of the at least one roll of the roll coating machine.

Preferably the support chassis includes at least one guide means for guiding the cloth strip so as to facilitate relative movement between the cloth strip and the at least one roll of the roll coating machine.

Preferably there is provided a transport means for transporting the cloth strip relative to the at least one roll of the roll coating machine. Preferably the transport means includes a delivery or uncoiling means to deliver or supply clean cloth strip from a supply coil to the at least one die or mandrel. Preferably the transport means further includes drawing means so as so draw clean cloth from the uncoiling means or supply coil. Also, the transport means may include a packing means to pack spent cloth strip which has cleaned the roll face, neck and/or end surfaces of the at least one roll of the roll coating machine.

The packing means may include a coiling means for recoiling the spent strip onto a spent coil or a dumping means which includes a shear and dump box for transport of spent cloth strip, sheared into selected lengths, to a dump or recycling or cleaning facility.

Preferably the coiling means includes an indexing means so as to facilitate drawing the cloth strip from the supply coil, the indexing means being preferably in the form of a ratchet operated by a pneumatic cylinder.

Preferably the support chassis includes a solvent delivery means for delivering solvent to the cleaning cloth strip. In one form the solvent delivery means includes galleries associated with or disposed within the support spine and dies or mandrels, so as to impregnate the cleaning cloth strip at approximately the time of passing between the die and the roll or roll neck surface.

Preferably the guide means include folding or tucking means so that the cleaning cloth strip may form convex or deep contours so as to facilitate cleaning of roll end faces and the like. Generally the cleaning cloth forms a U-shape adjacent the coating machine rolls when in operation. In one form the guide means include guide blocks which include guide slots which are open at a base for receiving a side region of the cloth strip and are disposed generally perpendicular to a plane of an upstream cleaning cloth strip. Preferably an upstream guide block and a downstream guide block are provided for each die or mandrel so as to facilitate accurate contouring of the cloth strip to the die or mandrel profile.

Preferably the guide blocks are pivotally mounted on the mounting spine so as to facilitate close correspondence of the contour of the cloth strip with the contour of the roll or roll end or roll neck surface.

It may be in some embodiments that the support chassis and cleaning element is the full width of a roll and neck of the at least one roll of the coating machine. Preferably, however, the support chassis and cleaning element is only narrow compared to the width of the roll, and a traversing means is provided so as to traverse across the surface of the roll and neck at a selected speed. In one optional form the traversing means is mounted on the pickup roll support structure.

A linear actuator being hydraulic, pneumatic or electric, including a linear track may be included with the traversing means, and the track may extend to one side of the coating machine so as not to interfere with a coating operator's view of the coating operation.

Furthermore, transducers such as position and pressure sensors may be provided with the traversing means so as to provide feedback to a logic controller which may control the traverse of the cleaning element. The traversing means may include a counterbalance assembly so as to maintain side-to-side accuracy of measurement of roll force between pickup rolls and applicator rolls when the coating machine is in coating operation.

According to still another aspect of the present invention there is provided a roll coating machine for coating coil or strip, the roll coating machine including at least one roll, the roll coating machine including: a cleaning means in the form of a spray head for cleaning a fluid reservoir; and a support chassis for supporting the cleaning means adjacent the fluid reservoir.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

In order to enable a clearer understanding of the invention, drawings illustrating example embodiments are attached, and in those drawings:

FIG. 1 is an isometric view of a portion of a roll coating machine which has a cleaning apparatus for a roll coating machine according to a preferred embodiment of the present invention;

FIG. 2 is the isometric view of FIG. 1 but with a cleaning element removed for clarity;

FIG. 3 is a side elevation view of the roll coating machine with the cleaning apparatus of FIGS. 1 and 2;

FIG. 4 is a plan view of the roll coating machine with the cleaning apparatus of FIGS. 1-3;

FIG. 5 is a plan view of a roll coating machine having a cleaning apparatus installed according to a preferred embodiment of a second aspect of the present invention;

FIG. 6 is a side elevation view of the roll coating machine having the cleaning apparatus shown in FIG. 5 installed;

FIG. 7 is a plan view of a reservoir according to a preferred embodiment of another aspect of the present invention;

FIG. 8 is a side elevation view of the reservoir of FIG. 7 with some internal details shown;

FIG. 9 is a section view along B-B of FIG. 8;

FIG. 10 is a section view along A-A of FIG. 8;

FIG. 11 is an isometric view of a cleaning assembly in accordance with a third preferred embodiment of the present invention;

FIG. 12 is a side elevation view of the cleaning assembly of FIG. 11;

FIG. 13 is an isometric view of the guide and mandrel assembly, forming part of the cleaning assembly of FIG. 11;

FIG. 14 is an end elevation view of the guide and mandrel assembly of FIG. 13;

FIG. 15 is an isometric view of the guide and mandrel assembly of FIG. 13, the guides being in a folded position;

FIG. 16 is a plan view of the guide and mandrel assembly of FIGS. 13 and 15, the guides being in a released or unfolded position, as in FIG. 13;

FIG. 17 is a plan view of the guide and mandrel assembly of FIGS. 13-16, the guides being in the folded position shown in FIG. 15; and

FIG. 18 is an end elevation view of the guide and mandrel assembly of FIGS. 13-17, the guides being in the folded position.

### DETAILED DESCRIPTION OF PREFERRED EMBODIMENTS

It is to be understood that there are several distinct aspects of the present invention and these will be hereinafter described in combination with one another, and this is not to detract from the separate and distinct nature of the aspects of the inventions.

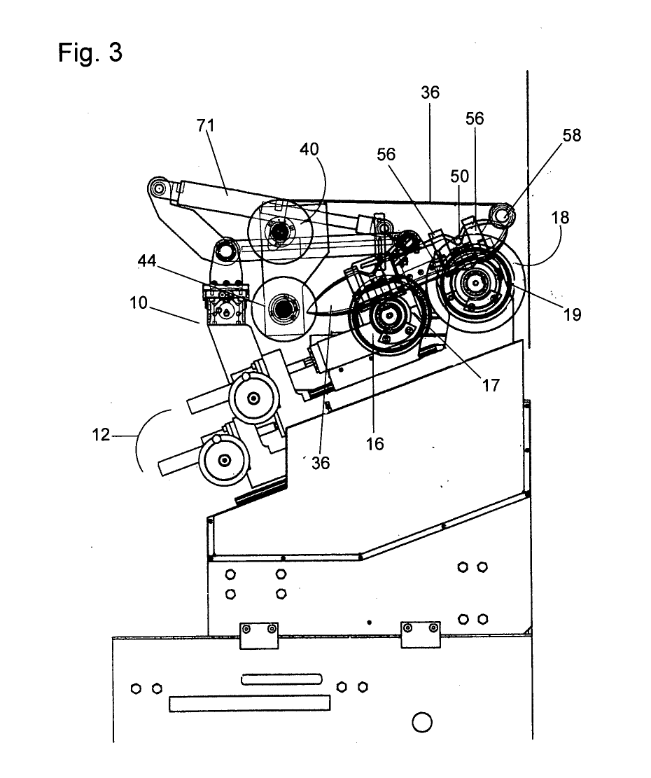

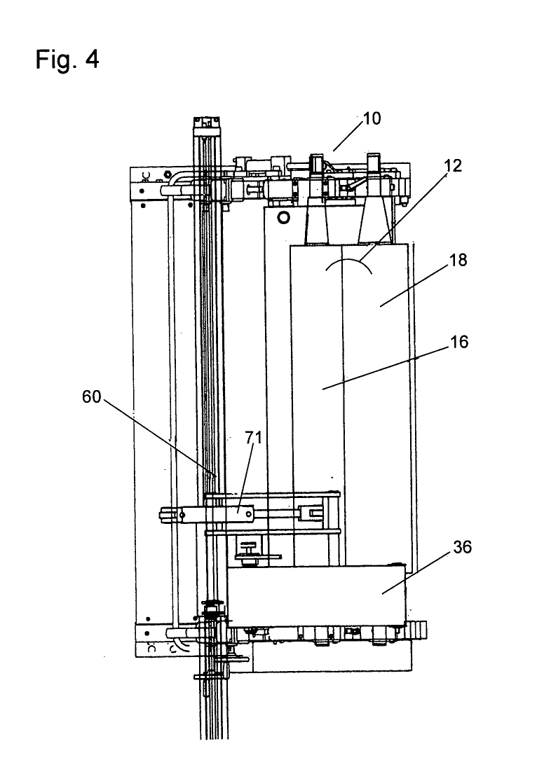

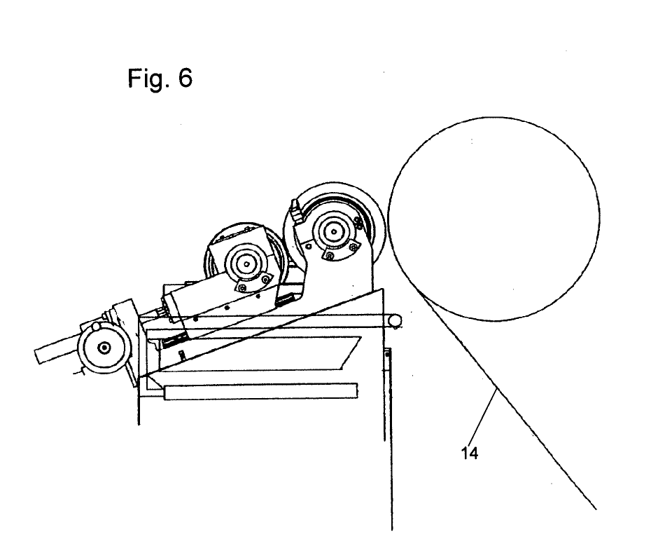

Referring to the figures, there is shown a roll coating machine 10, generally indicated at 10, which includes a roll assembly 12 for coating a strip or coil 14, in FIGS. 3 and 6. The roll assembly 12 includes at least one roll, with each roll including at least one roll neck, at least one roll shoulder and one roll face. The roll assembly 12 includes a pick-up roll 16 which in use picks up paint (not shown) from a reservoir 80 and transfers it to an applicator roll 18 which in turn applies the paint to the strip or coil 14, in FIGS. 3, 4 and 6. The pick-up roll 16 comprises at least one roll neck 17, and the applicator roll 18 includes at least one roll neck 19, in FIG. 3.

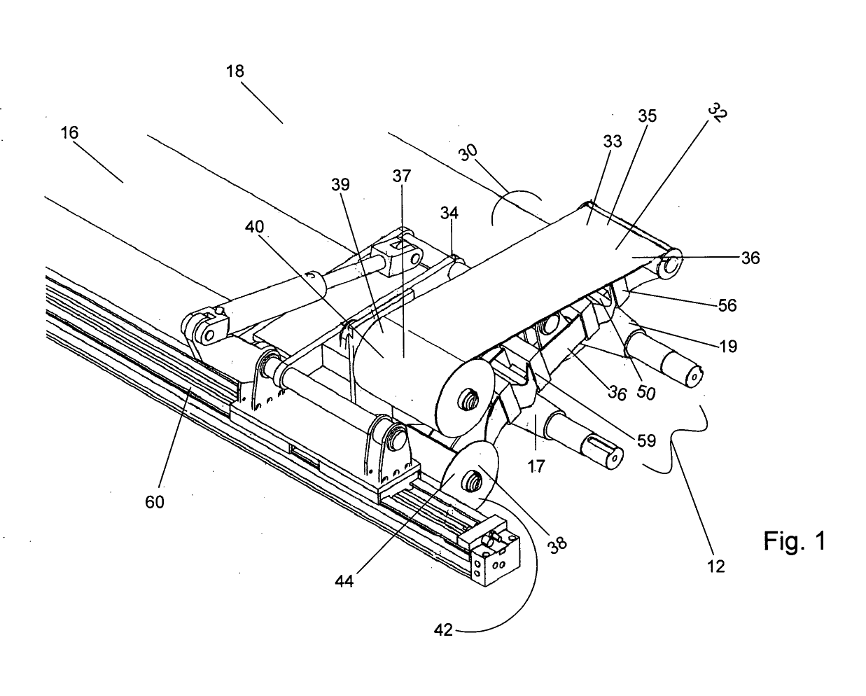

In FIG. 1, a cleaning apparatus 30 is provided, generally indicated at 30, and includes a cleaning means 32 and a support chassis 34 for supporting the cleaning means 32 at a selected position relative to the roll assembly 12. The cleaning means 32 includes a cleaning element 33 which is in the form of a wiper 35 in the form of a cloth strip 36. The cloth strip 36 is mounted on a transport means 38 for transporting the cloth 36 relative to the roll assembly 12. The transport means 38 includes a delivery means 39 in the form of an uncoiling means 37 in the form of a supply coil 40 so as to supply clean cloth strip 36 to the roll assembly 12. The transport means 38 further includes a coiling means 42 which coils and draws the cloth strip 36 from the supply coil 40, over the roll assembly 12 and onto a spent coil 44.

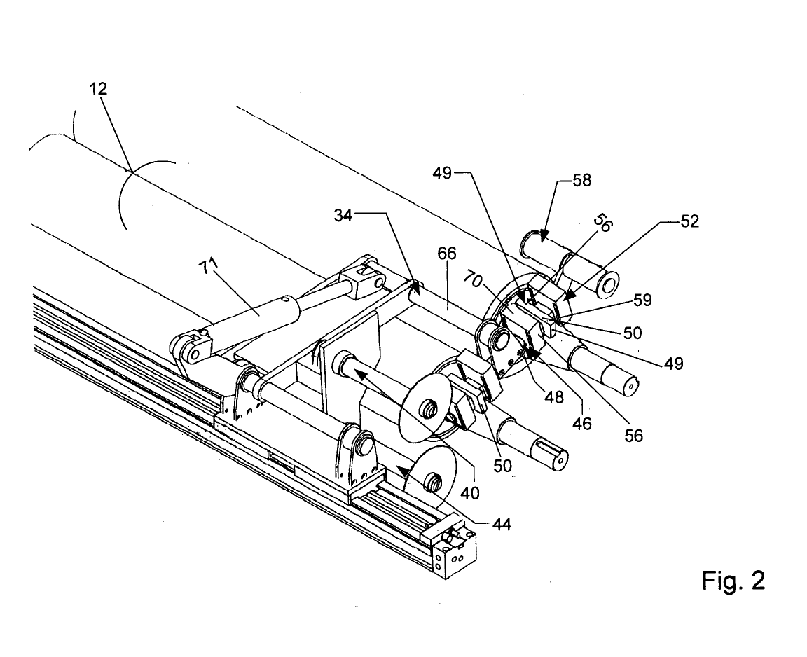

In FIG. 2, the support chassis 34 includes a mounting spine 46 in the form of a mounting shaft 48 so that cleaning element support means 49 may be pivotally mounted thereon.

In FIGS. 1-3, the cleaning element support means 49 includes a die or mandrel 50, or similar device, in order to facilitate broad cleaning contact between a cleaning surface of the cloth strip 36 and at least one surface of the roll assembly 12. At least a portion of the die 50 is shaped to correspond to the shape of each roll neck 17 and 19 so as to improve cleaning thereof by the cloth strip 36. At least one die 50 is provided per roll assembly 12.

In FIG. 2, the support chassis 34 may include a cleaning fluid delivery system 66 so as to enhance cleaning of the roll assembly 12. The cleaning fluid delivery system 66 includes a gallery means inside the die 50 so that fluid or solvent (not shown) may be directed to the cloth strip 36 adjacent the die 50. The support chassis 34 further includes a ram which can adjust pressure between the die 50 and the cloth strip 36, so improve cleaning of the roll surfaces.

In FIG. 2, the support chassis 34 also includes guide means 52 to guide the cloth strip 36 from the supply coil 40 to the spent coil 44. The guide means 52 include guide blocks 56 and turn rolls 58, so as to facilitate smooth running of the cloth strip 36 around the dies 50 and back to the spent roll 44. The guide blocks 56 include guide apertures 59, open at one end so that the cloth strip 36 may form a generally concave and U-shaped profile which corresponds to various features of the roll assembly 12, and assists with getting into corners (roll end shoulder) and the like to facilitate cleaning At least two guide blocks 56 are provided per die 50, one upstream and one downstream so as to improve flow of cloth strip 36 across the face of the mandrel or die 50.

In at least one arrangement, the die 50 and guide means 56 includes lateral adjustment means 70 and 170 so that greater contact may be made between the cloth strip 36 and the roll assembly 12. The adjustment means 70 and 170 includes spring adjusters on apertures (not shown). A traversing means 60 is provided to move the cloth strip 36 along the length of the roll assembly 12. The traversing means 60 includes a track 62 which extends past the roll necks 17 and 19 so that it may be parked out of the vision of a coating operator (not shown). The traversing means 60 also includes an actuation means which may be hydraulic, electric, or pneumatic. A counterweight is also provided so as to inhibit side-to-side inaccuracies in measurement of pressure between pick-up roll 16 and applicator roll 18.

The die 50 and guide blocks 56 are pivotally mounted on shaft 48 so that, during traversing of the traversing means 60, substantially optimum contact is maintained between cloth strip 36 and roll faces, roll ends and roll neck faces. A reservoir 80 is provided so as to catch coating fluid or to supply cleaning fluid (not shown) to the pick-up roll 16. The reservoir 80 includes two chambers—a first, 82 and a second, 84.

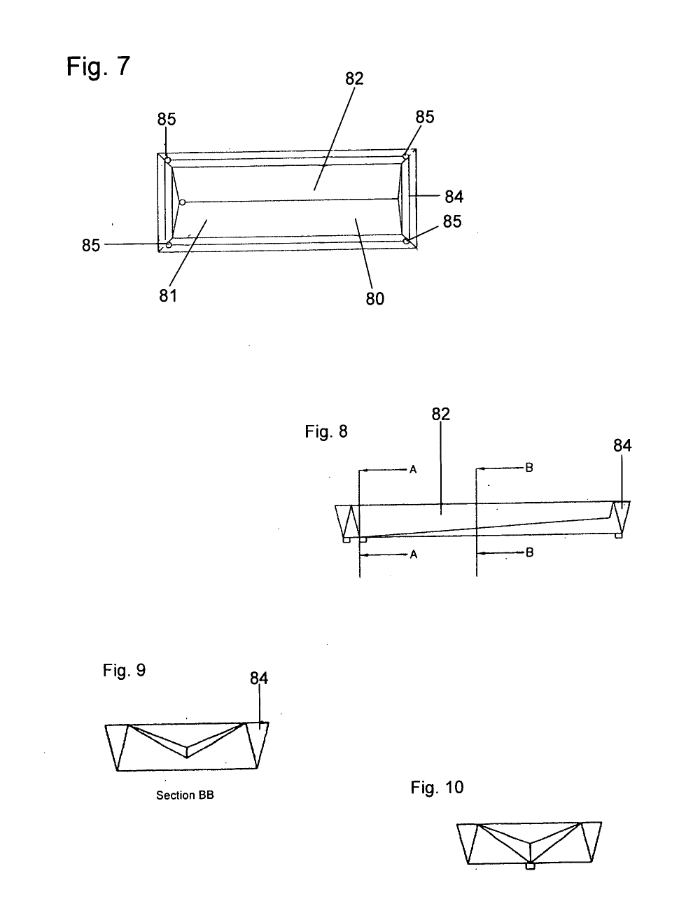

In FIGS. 7-10, the first chamber 82 is centrally disposed on a main reservoir body 81 for catching prime coating fluid and supplying it to the pickup roll 16, and the second chamber 84 is disposed around the periphery of the first chamber 82 for catching overspray and drips. Both chambers 82,84 drain to separate, respective drains 85 so as to filter overspray with its attendant potential contaminants, from prime coating fluid.

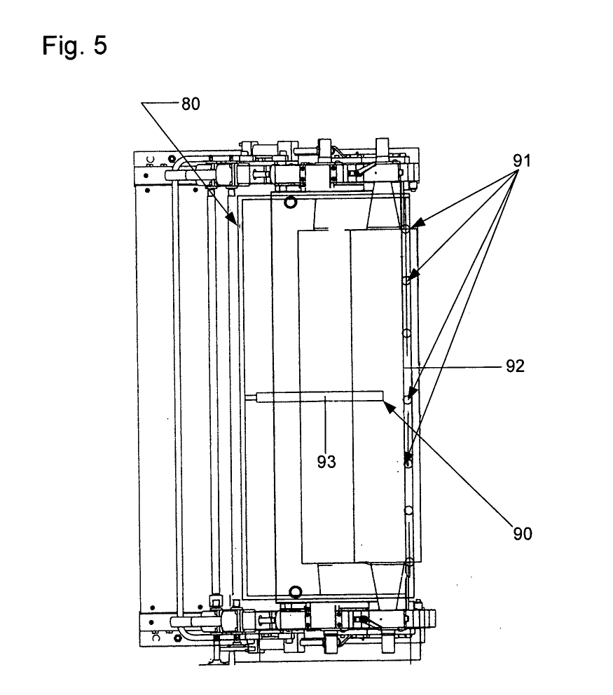

In FIGS. 7-10, the first chamber 82 includes tapering walls and floors to improve drainage. The second chamber 84 provides slightly less fall, if any, to the drains 85, but there are four drains 85 provided in the second chamber 84 to improve drainage. In FIG. 5, a cleaning means 90 in the form of a row of spray heads 91 is provided to clean the reservoir 80. In FIG. 5, the support chassis 34 in this case includes a spray head mounting bar 92 and a traversing means 93 in the form of a linear actuator (not shown) so as to move the spray heads 91 in a direction normal to the axis of the spray bar 92. The traverse allows the whole reservoir 80 to be cleaned.

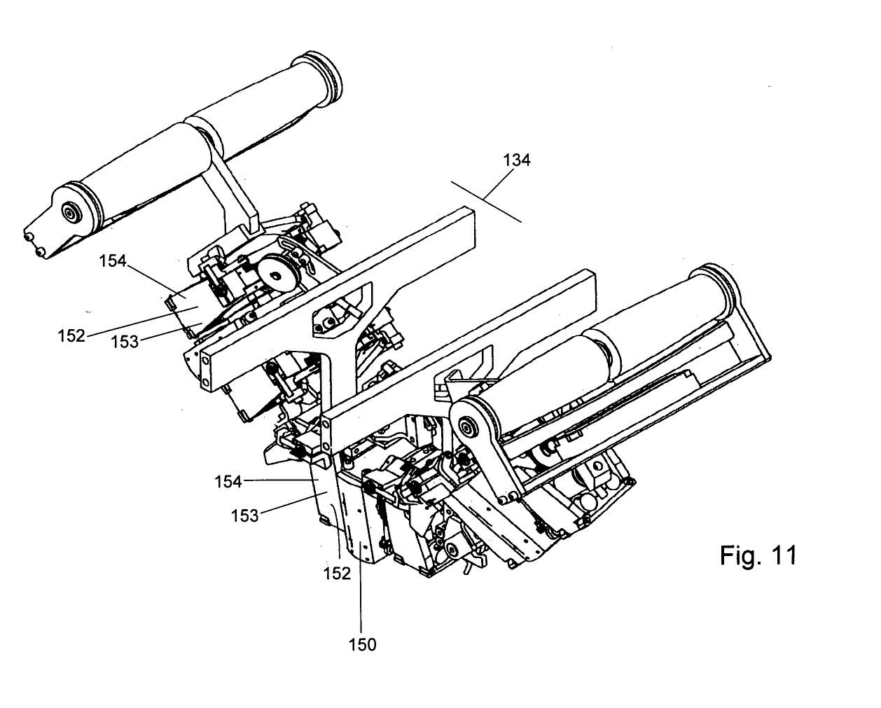

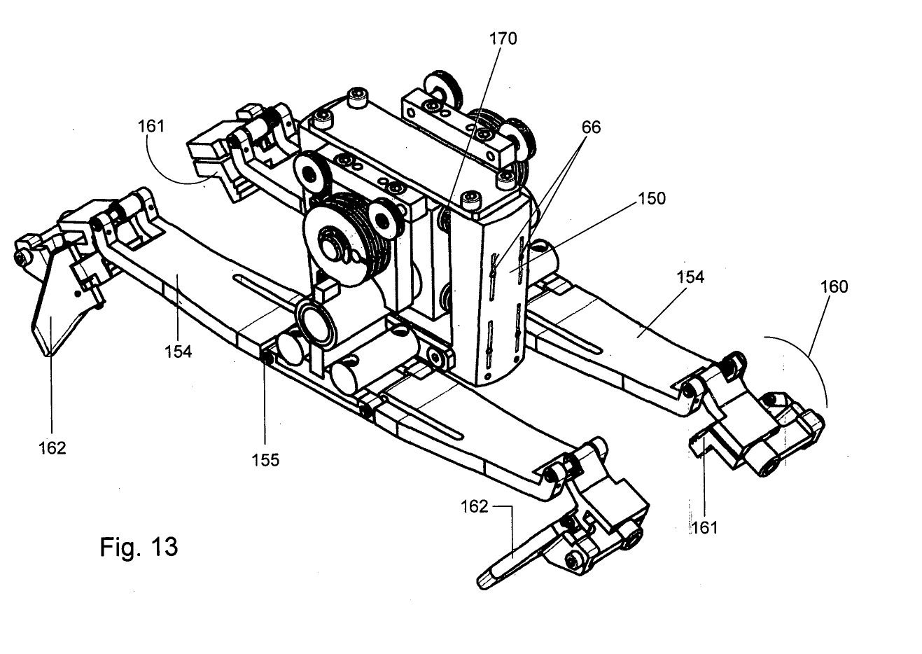

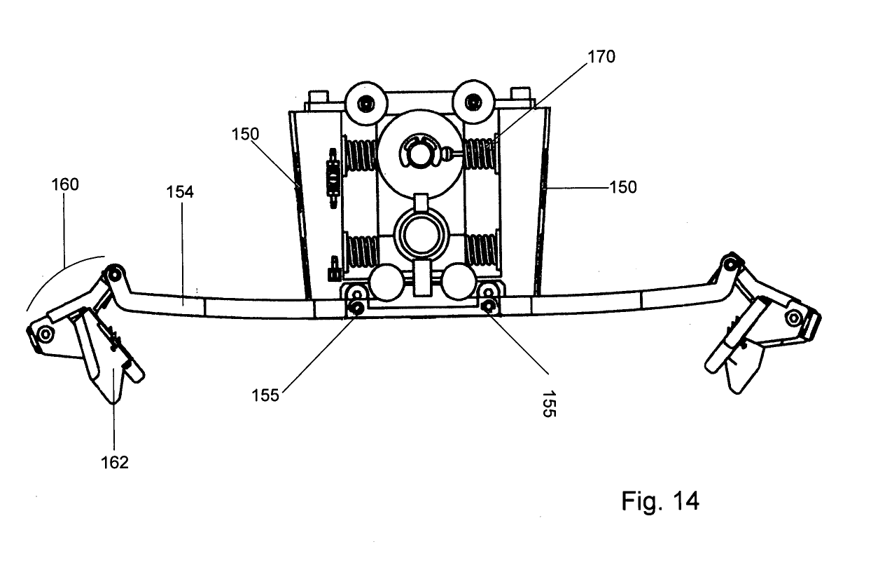

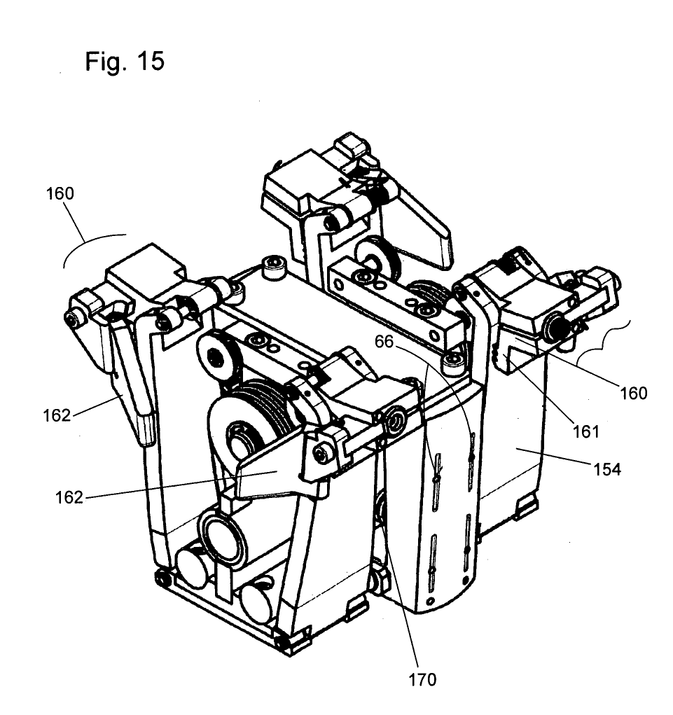

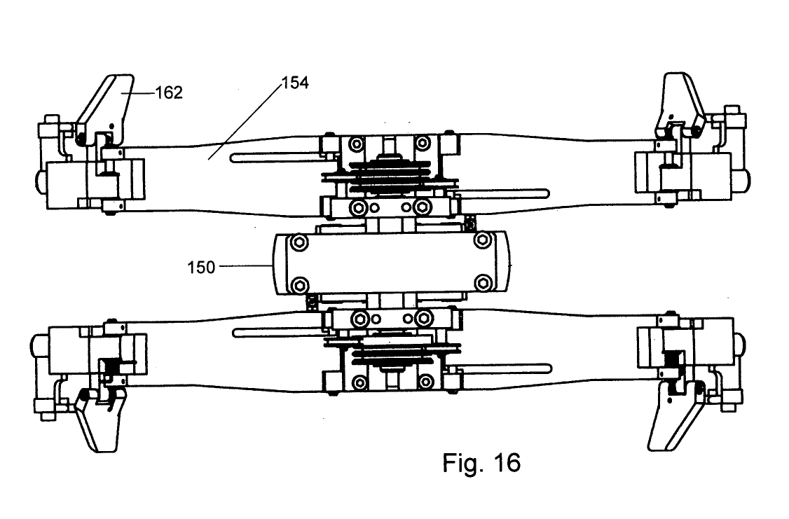

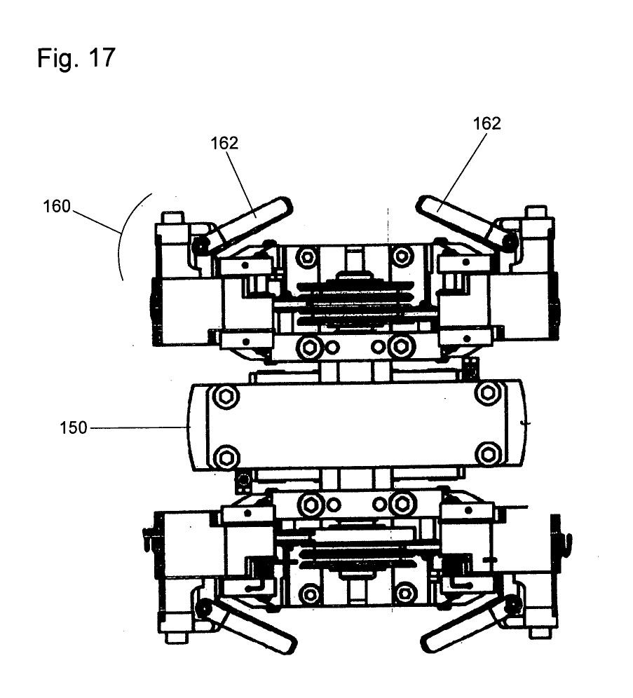

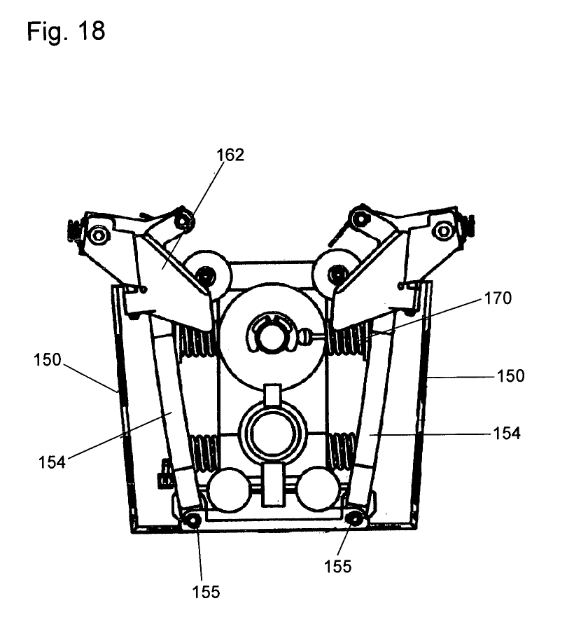

Another arrangement of support chassis 134 is shown at FIGS. 11-18. In that arrangement, the guide means 152 includes movable or adjustable guide elements 153. The guide elements 153 are elongate and in the form of laterally-extending wings 154 which are adapted to pivot about pivots 155. The wings 154 can pivot between: a folded or retracted position shown in FIGS. 11, 12, 15, 17 and 18; and an unfolded or flat position shown in FIGS. 13, 14 and 16. In the flat position the cloth strip 36 is free to index along between the uncoiler and the coiler to supply fresh cloth strip 36, and to clean a flatter area. In both the retracted position and the flat position the cloth strip 36 can be locked in position and held taut so as to retain the cloth strip 36 in a cleaning position.

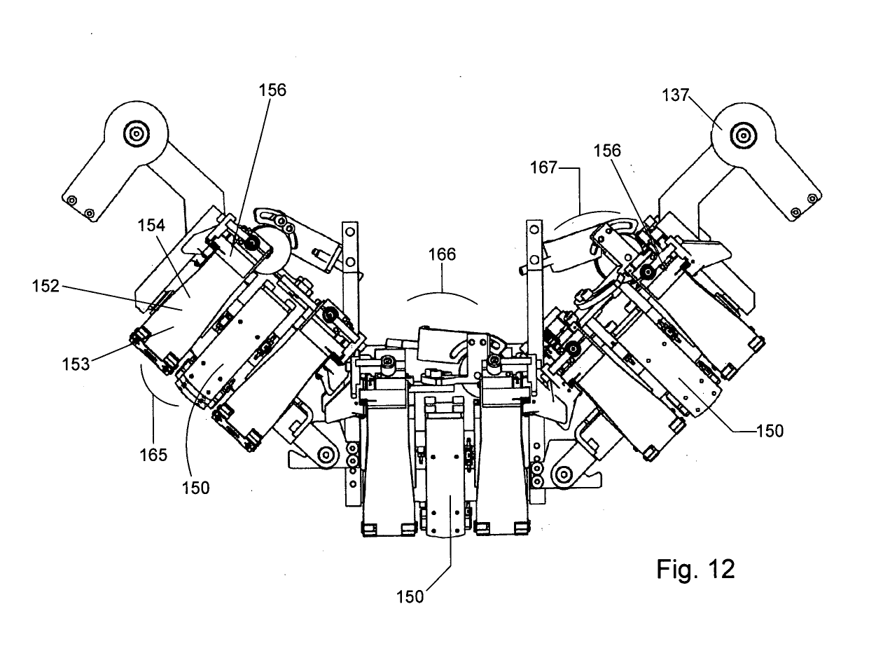

In FIGS. 11 and 12, the locking can be achieved by clamps 156 which when clamped, hold the cloth strip 36 in a cleaning position. The clamps 156 include movable jaws 160 which comprise jaw elements 161 and tensioning elements 162. The jaw elements 161 are disposed at distal ends of the wings 154 and also pivot between clamped and free positions. Cables (not shown) are provided to move the clamps 156 and wings 154 between their respective positions. Drawing on the cables overcomes biasing forces on the wings and clamps so as to release the cloth strip 36. The biasing forces on the clamps 156 are lighter than those for the wings 154 so that the clamps 156 may be released before the wings 154 move, so that the cloth strip 36 may be released without moving the wings 154.

There are three dies 150 in the support chassis 134 shown in FIGS. 11 and 12, and there is a pair of guide elements 153 associated with each die 150, one disposed upstream and the other disposed downstream, for improved flow of strip over the die 150. The support chassis 134 can be moved into a straight or arcuate shape to suit a surface to be cleaned. This is achieved by pivoting guide assembly 165 relative to 166, and 167 etc.

Throughout this specification and the claims which follow, unless the context requires otherwise, the word “comprise”, and variations such as “comprises” or “comprising”, will be understood to imply the inclusion of a stated integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1.-21. (canceled)

22. A cleaning apparatus suitable for cleaning a roll coating machine having at least one roll, at least one roll neck, at least one roll shoulder, and one roll face, the cleaning apparatus comprising:
a cleaning means for cleaning the at least one roll neck and the at least one shoulder;
a support chassis for supporting the cleaning means adjacent the at least one roll; and
a mounting means for mounting the cleaning apparatus to the roll coating machine.

23. A cleaning apparatus in accordance with claim 22 wherein the cleaning means is adapted to clean the roll face.

24. A cleaning apparatus in accordance with claim 22 wherein the cleaning means is a contact cleaning means in the form of a wiper element.

25. A cleaning apparatus in accordance with claim 24 wherein the wiper element is a cloth element in the form of a cloth strip.

26. A cleaning apparatus in accordance with claim 25 wherein at least one mandrel is provided so that when the cloth wiper element extends between a first and second roll neck and shoulder ends, a wiping surface of the wiping element corresponds in shape to at least one surface of the at least one roll neck and shoulder of the roll.

27. A cleaning apparatus in accordance with claim 26 wherein the support chassis includes a mounting spine for mounting the at least one mandrel so that in an in-use position they abut the roll or roll neck or shoulder surfaces.

28. A cleaning apparatus in accordance with claim 27 wherein the mounting spine is an articulated elongate shaft.

29. A cleaning apparatus in accordance with claim 28 wherein the at least one mandrel is adapted to pivot about the elongate shaft, abut a longitudinal shaft axis to facilitate broader contact between cloth strip and the at least one surface of the at least one roll.

30. A cleaning apparatus in accordance with claim 29 wherein the at least one mandrel is adapted within its internal dimensions to shift horizontally with springs biasing each mandrel to return to a center position.

31. A cleaning apparatus in accordance with claim 22 wherein the support chassis includes at least one guide means for guiding the cloth strip, whereby proper positioning of the cloth strip relative to the surfaces of the at least one roll and relative movement between the cloth strip and the at least one roll of the roll coating machine is facilitated.

32. A cleaning apparatus in accordance with claim 22 further including a transport means for transporting the cloth strip relative to the at least one roll of the roll coating machine.

33. A cleaning apparatus in accordance with claim 32 wherein the transport means includes a delivery means to deliver a clean cloth strip from a supply coil to the at least one mandrel.

34. A cleaning apparatus in accordance with claim 32 wherein the transport means includes a drawing means to draw clean cloth away from the supply coil.

35. A cleaning apparatus in accordance with claim 32 wherein the transport means includes a packing means to pack spent cloth strips.

36. A cleaning apparatus in accordance with claim 35 wherein the packing means includes a coiling means for recoiling each spent strip onto a spent coil.

37. A cleaning apparatus in accordance with claim 35 wherein the packing means includes a dumping means which includes a shear and dump box for transport of spent cloth strips sheared into selected lengths.

38. A cleaning apparatus in accordance with claim 36 wherein the coiling means includes an indexing means to facilitate drawing the cloth strip away from the supply coil.

39. A cleaning apparatus in accordance with claim 22 wherein the support chassis includes a solvent delivery means for delivering solvent to each cleaning cloth strip.

40. A cleaning apparatus in accordance with claim 39 wherein the solvent delivery means includes galleries within the support spine and/or the at least one mandrel, to impregnate the cleaning cloth strip at approximately the time of passing between the die and the roll or roll neck surface.

41. A cleaning apparatus in accordance with claim 31 wherein the guide means include a folding or tucking means.

42. A cleaning apparatus in accordance with claim 22 further including a traversing means to move the support chassis up and across the surface of the roll neck.

43. A roll coating machine for coating a coil or strip, the roll coating machine comprising:
at least one roll each comprising a roll face and at least one roll neck;
a cleaning means for cleaning each roll neck; and
a support chassis for supporting the cleaning means adjacent each roll.
